(19) United States
(12) Patent Application Publication
(10) Pub. No.: US 2025/0137491 A1
(43) Pub. Date: May 1, 2025

(54) SEALING ASSEMBLY INSERTABLE BETWEEN A STATIONARY ANNULAR ELEMENT AND A SLIDING ANNULAR ELEMENT, IN PARTICULAR AN OUTER CASING AND A SHOCK-ABSORBER ROD OF A VEHICLE

(71) Applicant: AKTIEBOLAGET SKF, GOTEBORG (SE)

(72) Inventors: Marco BRESSO, Torino (IT); Adriano VALSANIA, Riva presso Chieri (IT); Alice AMERIO, San Paolo Solbrito (IT)

(21) Appl. No.: 18/924,206

(22) Filed: Oct. 23, 2024

(30) Foreign Application Priority Data
Oct. 30, 2023 (IT) 102023000022824

(51) Int. Cl. F16C 33/74

(52) U.S. Cl. CPC F16C 33/74

(57) ABSTRACT

A sealing assembly for a bicycle shock absorber includes an annular elastomeric body comprising a solid median portion, a first annular sealing lip and a second annular sealing lip. An annular support is at least partially embedded in the elastomeric body. The first annular sealing lip projects radially inward and projects in a first axial direction from a first axial end of the solid median portion, the second annular sealing lip projects radially inward and in a second axial direction from a second axial end of the solid median portion, and the second annular sealing lip is flared in radial cross-section towards a free end of the second annular sealing lip, the free end being opposite a root portion of the second annular sealing lip at the second axial end of the solid median portion.

### CROSS-REFERENCE

This application claims priority to Italian patent application no. 102023000022824 filed on Oct. 30, 2023, the contents of which are fully incorporated herein by reference.

### TECHNOLOGICAL FIELD

The present disclosure is directed to a sealing assembly suitable for mounting between a stationary annular element and a movable—in particular sliding—annular element in order to seal in a fluid-tight manner a cavity delimited between these elements where pressurized oil (or another fluid) is present. In particular, the invention relates to a sealing assembly for a vehicle shock absorber, in particular for bicycles, intended to form a seal on the sliding rod of the shock absorber in order to retain lubricating fluid and pressurized air inside the shock absorber and, at the same time, prevent the entry of external contaminants.

### BACKGROUND

Known shock absorbers for bicycles, in particular for so-called “mountain bikes,” may include sealing assemblies called “fork seals.” These may comprise an elastomeric body mounted on a rigid element or “core” that is embedded in the elastomeric body and from which elastomeric body extend two annular sealing lips, i.e. a first lip directed towards the inside of the shock absorber body and a second lip directed towards the outside of the shock absorber body. Both lips cooperate in a sliding manner, during use, with the shock-absorber rod, which slides inside an annular tubular element or outer casing and is lubricated with oil or other viscous lubricating fluid.

The first lip, known as “oil lip,” has the main function of withstanding the hydraulic and pneumatic pressures present inside the shock absorber so as to avoid the occurrence of oil leakages and pressure losses outside the shock absorber. The second lip, known as “dust protection lip,” has the function of preventing the penetration of external contaminants (dust, water, mud) towards the oil lip.

The latest generation of bicycle forks aim to provide a higher internal pressure inside the shock absorber body of the fork, in particular in high compression conditions, which normally occur during downhill riding and braking. Here and below “high pressures” is understood as meaning a pressure of between 4 and 7 bar, or higher.

The high pressure inside the shock absorber acts on the oil lip of the fork seal and creates a radial load which at higher pressures also increases considerably, thus creating greater non-uniform friction. Moreover, the high pressure on the oil side tends to deform the seal and therefore the dust protection lip loses significantly its effectiveness with regard to the radial load. Consequently, the performance of the dust protection lip deteriorates considerably as a result of the increase in the working pressure of the fork shock absorbers.

These problems also remain when both the sealing lips are provided radially on the outside with radial compression springs which, above all, increase the overall size of the sealing assembly, in particular in the axial direction.

### SUMMARY

An aspect of the present disclosure is to provide an improved sealing assembly which overcomes the drawbacks of the prior art, while being simple and low-cost to manufacture and compact in terms of its size, in particular its axial dimensions.

According to the embodiments of the invention, a sealing assembly is provided which is insertable between two relatively axially sliding annular elements, in particular between an element and a shock-absorber rod of a bicycle fork. The disclosure also relates to a shock absorber for vehicles, in particular bicycles, provided with such a sealing assembly acting on the shock-absorber rod.

Disclosed herein is a new oil lip configuration that is able to lessen the radial load acting thereon also when high pressures are present and, consequently, ensure a constant friction despite the increase in pressure. Furthermore, owing to this new design, the deformation of the seal during use is prevented, or at least reduced, ensuring a stable performance of the dust protection lip also in the case of pressure peaks.

### BRIEF DESCRIPTION OF THE DRAWINGS

The invention will now be described with reference to the attached drawings which illustrate a practical non-limiting example of an embodiment thereof, in which:

FIG. 1 is a schematic sectional elevational view of an end portion of a shock absorber equipped with a sealing assembly according to an embodiment of the present disclosure.

FIG. 2 is a schematic sectional view of an annular half of the sealing assembly of FIG. 1.

FIG. 3 is a schematic sectional view of the radial profile of the sealing assembly of FIG. 2.

### DETAILED DESCRIPTION

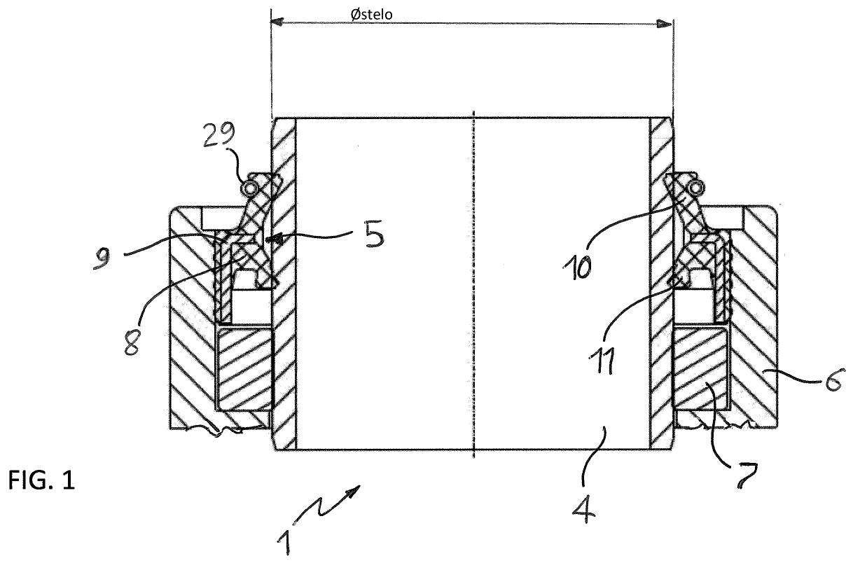

With reference to FIG. 1, the reference number 1 denotes overall a shock absorber for a vehicle, in particular for a bicycle fork (the fork and bicycle being known and not shown for the purposes of simpler illustration), comprising a shock-absorber rod 4—which in the example shown is tubular—arranged coaxially inside an element or outer casing 6 which is also tubular and with respect to which the rod 4 is axially slidable, and a sealing assembly 5 interposed between the rod 4 and the element 6.

More generally, the sealing assembly 5 is insertable between a movable—in this case sliding—annular element, such as the rod 4, and a stationary annular element, such as the element 6, which is known and generally forms the outer element of the shock absorber 1. In this embodiment, the element 6 also houses a stationary sponge ring 7 having a lubricating function for the shock-absorber rod 4.

The sealing assembly 5 is therefore, more generally, insertable between any two relatively sliding annular elements which, in the example shown, are the rod 4 and the element or outer casing 6. The shock absorber 1 is a shock absorber for vehicles and, in particular, for bicycle forks.

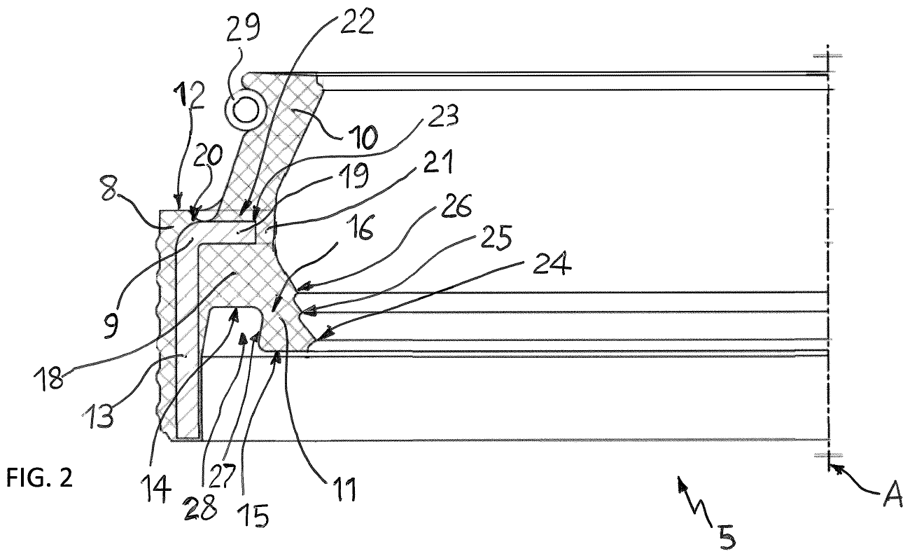

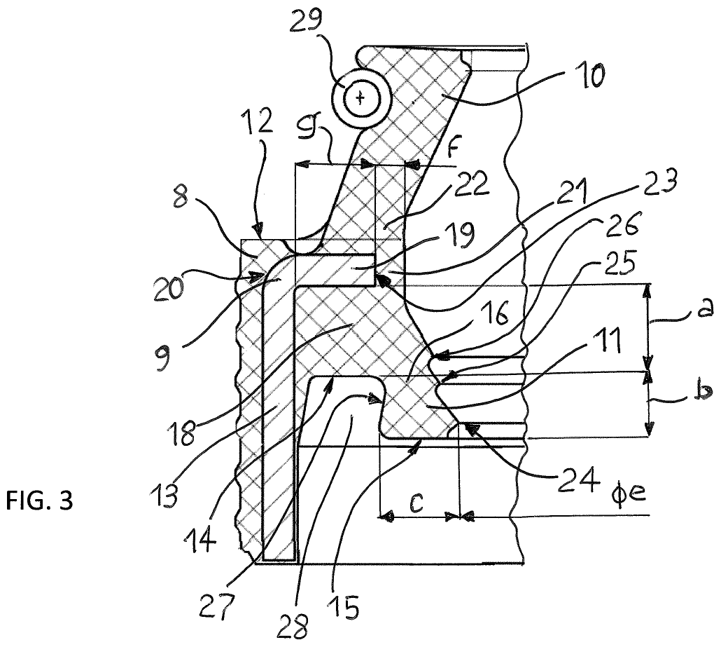

With reference also to FIGS. 2 and 3, the sealing assembly 5 comprises an annular element 8 made of an elastomeric material, for example rubber, a substantially rigid annular support 9, preferably made of metallic material, such as steel, and first and second opposite annular sealing lips 10 and 11 formed integrally as one piece with the elastomeric annular body 8 and made of the same elastomeric material or an elastomeric material compatible with that of the annular body 8 and co-molded therewith. The annular sealing lips 10 and 11, since they are made from an elastomeric material, are therefore elastically deformable.

The substantially rigid annular support 9 is coupled integrally with the elastomeric annular body 8 and is at least partially embedded therein and is rigidly joined together with the elastomeric annular body 8 by means of a known process of vulcanization gluing.

The annular sealing lips 10 and 11 are cantilevered and extend axially and radially from the inside of the elastomeric annular body 8. Specifically, the first annular sealing lip 10 projects axially cantilevered from a first end 12 of the elastomeric annular body 8, axially on the outside thereof and the second annular sealing lip 11 projects axially on the inside of a sleeve portion 13 of the annular support 9, from a front face 14 of the annular body 8 on the opposite side to the end 12.

According to a first aspect of the disclosure, the second annular sealing lip 11 is flared in radial cross-section (i.e. becomes radially wider) in a direction towards a free end 15 thereof. Here and below “free end” is understood as meaning the terminal portion of a cantilevered element, such as the lip 11, furthest from the point of constraint of the cantilevered element—in the case in question furthest from the front face 14 from which the lip 11 extends in a cantilevered manner—integral as one piece with the rest of the elastomeric annular body 8.

The free end 15 is opposite to a root portion 16 of the second annular lip 11, which is in turn immediately adjacent to the front face 14 of the annular body 8 to which it is connected as a single body.

Basically, therefore, the second annular sealing lip 11 is configured so that, at or near its free end 15, it has a maximum radial thickness “c” (FIG. 3), measured in a radial direction, greater than a minimum thickness, again measured in a radial direction, of its root portion 16. The sealing lip 11 is therefore configured, in radial cross-section, as a wedge having its widest part, namely the face of the base, situated at the free end 15, and the apex missing since it is incorporated or “embedded” inside the annular body 8 with which the annular lip 11 is integral.

Moreover, the annular sealing lip 11 has, between the root portion 16 and the free end 15, a predefined axial extension “b” (FIG. 3) which, on the basis of experimental tests carried out by the Applicant, has proved to be a critical parameter for the purposes of the optimum functionality of the sealing assembly 5.

According to another aspect of the disclosure, an optimum parameter for correct and efficient definition of the dimensions of the annular sealing lip 11 is that the ratio between the maximum thickness “c” of the free end 15 and the predefined axial extension “b” of the annular sealing lip 11 should be greater than or equal to 0.9 and less than or equal to 1.9.

The front face 14 of the annular body 8 delimits a median portion 18 (“median” in the sense that it is arranged “midway,” or in any case between, the two opposite sealing lips 10 and 1) which is solid (namely, has a radial cross-section fully occupied by the elastomeric material from which the annular body 8 is made) of the annular body 8. The median portion 18 is arranged radially on the inside of the sleeve portion 13 of the annular support 9 and extends axially within the sleeve portion 13 of the same substantially rigid annular support 8. The solid median portion 18 of the annular body 8 has a predefined axial extension “a” (FIG. 3). The front face 14 of the annular body 8 may also be referred to as a second end of the median portion 18.

According to one aspect of the disclosure, for correct operation of the sealing assembly 5, the solid median portion 18 of the elastomeric annular body 8 and the annular sealing lip 11 must be configured so that the ratio between the predefined axial extension “b” of the lip 11 and the predefined axial extension “a” of the median portion 18 is greater than or equal to 0.4 less than or equal 1.15.

The substantially rigid, metallic, annular support 9 has, in addition to the sleeve portion 13, a flange portion 19 which extends radially inwards from a first end 20 of the sleeve portion 13 so that the annular support 9 has, in radial cross-section, an upside-down L shape (FIG. 2).

The first end 20 of the sleeve portion 13 is in fact directed towards and is arranged at the first end 12 of the elastomeric annular body 8.

The flange portion 19 is completely embedded in the elastomeric annular body 8 and delimits on the opposite flank (i.e. on the opposite side) to the front face 14 of the elastomeric annular body 8, the solid median portion 18 of the latter.

Owing to this position, the flange portion 19 of the annular support 9 is configured to act as an axial support and shoulder for the solid median portion 18 of the elastomeric annular body 8 which may therefore transmit onto it, at least partially, axial stresses to which the median portion 18 and the annular sealing lip 11 integral therewith are subjected.

Similarly, the sleeve portion 13 is configured to acts as a radial support and shoulder for the solid median portion 18 of the elastomeric annular body 8 so as to take up at least partly the stresses which are transmitted, during use, to the solid median portion 19, for example by one or both sealing lips 10 and 11.

In order to ensure optimal operation of the sealing assembly 5, the end 12 of the elastomeric annular body 8 comprises a connecting portion 21 between the solid median portion 18 of the elastomeric annular body 8 and a root portion 22 of the first annular sealing lip 10. The connecting portion 21 is an elastomeric portion with a solid radial cross-section, like the median portion 18, and therefore devoid of the annular support 9, since it extends radially from a radially inner annular edge 23 of the flange portion 19 of the annular support 9.

According to one aspect of the disclosure, the flange portion 19 of the annular support 9 has a first predefined radial extension “g” (FIG. 3) and, in combination, the connecting portion 22 has not only an annular shape with solid radial cross-section, but also has a second predefined radial extension “f” (FIG. 3), measured from the radially inner edge 23 of the flange portion 19 of the annular support 9.

The flange portion 19 of the annular support 9 and the connecting portion 22 of the elastomeric annular body 8 are configured so that the ratio between the first predefined radial extension “g” and the second predefined radial extension “f” is always greater than or equal to 1.5 and less than or equal to 4.

According to a further aspect of the disclosure, in the proximity of the maximum radial thickness “c” of the free end 15 of the second annular sealing lip 11, the latter is provided radially on the inside with a first annular rib 24 configured to form, during use, a sliding sealing contact point on a sliding mechanical element such as the shock-absorber rod 4. The annular rib 24 has a known shape, but its specific positioning on the annular lip 11, as mentioned above, represents a choice which allows the sealing action of the annular lip 11 specifically, and of the sealing assembly 5 more generally, to be optimized. The second annular sealing lip 11 is also provided, again radially on the inside, with at least a second annular rib 25 configured to form, during use, a second sliding sealing contact point on the sliding mechanical element, in the case in question the rod 4.

According to one aspect of the disclosure, the second annular rib 25 is arranged axially closer to the front face 14 of the annular body 8 than the first annular rib 24. In particular, the second annular rib 25 is preferably arranged substantially flush with the front face 14 of the annular body 8.

Preferably, the second annular sealing lip 11 is provided, again radially on the inside, also with a third annular rib 26 configured to form, during use, a third sliding sealing contact point on the sliding mechanical element formed, in the non-limiting example shown, by the rod 4. The third annular projection 26 is arranged axially closer to the first annular sealing lip 10 than the front face 14 of the annular body 8 and therefore axially closer to the flange portion 19 than the other two annular ribs 24 and 25.

According to a preferred embodiment, the annular rib 26 may be omitted, but the two annular ribs 24 and 25 must both be present, in the axial positions indicated, in order to optimize the hydraulic sealing action of the lip 11.

Again for this purpose. the second annular sealing lip 11 is delimited, radially on the outside, by a tapered side surface 27 directed towards, i.e. facing, the sleeve portion 13 of the annular support 9 and having a taper directed towards the first annular sealing lip 10.

Here and below, “taper” is understood as meaning the direction or sense in which the ideal vertex of a tapered surface, in the case in question of the tapered side surface 27, is situated; in the example shown, the vertex intersects an axis of symmetry A of the sealing assembly 5 (FIG. 2) on the opposite side to free end 15 of the lip 11, so that the taper of the tapered side surface 27 is directed upwards in FIGS. 2 and 3.

Owing to the presence of the tapered side surface 27, an annular recess 28 is created between the second annular sealing lip 11 and the front face 14 of the elastomeric annular body 8 which recess has a radially inner wall inclined towards the axis A and is arranged opposite the minimum radial thickness of the root portion 16 of the second annular sealing lip 11.

This configuration may be useful for controlling how the internal pressure of the shock absorber 1 acting on the lip 11, in the case in question contained in the annular or tubular element 6, influences the radial hydraulic sealing pressure which the lip 11 and its main annular rib 24 (as well as the other annular ribs 25 and 26) exert during use on the sliding mechanical element on which the hydraulic sealing action must be exerted, in the case in question the shock-absorber rod 4.

Finally, again with the aim of fully optimizing the hydraulic sealing action of the sealing assembly 5 when it is applied to a shock-absorber rod 4, for example in the configuration shown in FIG. 1, Applicant has established that the interference during use which must occur between the oil lip 11 and the rod 4 depends on the ratio between the outer diameter Ø_{rod} of the rod 4 and the inner diameter Øe of the main annular sealing rib 24 of the lip 11, so that the following relation must always be satisfied:

$$1.8 \% \leq [ ( {∅}_{rod} - ∅ e ) / ( {∅}_{r o d} ) ] \leq 5.5 \% \qquad [ 1 ]$$

The configuration of the first annular sealing lip 10, finally, is of the traditional and known type and the lip is loaded (i.e. mechanically stressed) radially inwards by a (known) toroidal helical spring 29 to adjust its interference and contact pressure on the outer side surface of the rod 4.

However, owing to the general configuration described for the sealing assembly 5, the lip 10 has its root portion 22 arranged facing and immediately adjacent to the flange portion 19 of the annular support 9 so as to take up partly the stresses acting on the annular lip 10 and in particular allow the lip 10 to be mechanically separated from the lip 11 so that the deformations of the latter do not influence the lip 10.

Finally, from the above description it is clear for the person skilled in the art that the specific design used for the oil lip 11 is able to ensure less exposure to the oil pressure, owing to the smaller “height” (axial extension) of the lip 11. Moreover, the dimensional ratios described enable in any case the lip 11 to maintain its flexibility and therefore compensate for any radial misalignment.

Similarly, owing to the dimensions described and the configuration and position of the annular ribs 24 and 25 (as well as the rib 26 when present) which determine the points of contact, and therefore of hydraulic sealing, between the lip 11 and the rod 4 (or other sliding mechanical element to be sealed), a correct contact pressure on the rod or other sliding member 4 is ensured, with the result that the contact pressure of the annular sealing lip 11 is kept substantially constant, and therefore the friction kept low, even in the presence of high oil pressures. It has been determined in experimental tests that, with an increase in the oil pressure, the increase in the contact force of the lip 11 according to the disclosed design is equal to about half the increase in the contact force which occurs with a traditional design of the oil lip.

Finally, the dust protection lip 10 is able to ensure a constant radial load and therefore a constant performance as regards its contact pressure, owing to the improved support provided by the specific shape of the annular support 9 and in particular its two portions, i.e. sleeve portion 13 and flange portion 19. Moreover, the reduced radial thickness of the portion 21 results in a reduced possibility of bending and therefore a greater stability of the lips 10 and 11.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sealing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A sealing assembly for a bicycle shock absorber comprising:
an annular elastomeric body comprising a solid median portion, a first annular sealing lip and a second annular sealing lip, and
an annular support at least partially embedded in the elastomeric body,
wherein the first annular sealing lip is formed integrally with the solid median portion and projects radially inward and projects in a first axial direction from a first axial end of the solid median portion,
wherein the second annular sealing lip is formed integrally with the solid median portion and projects radially inward and in a second axial direction from a second axial end of the solid median portion, the second direction being away from the first annular sealing lip, and
wherein the second annular sealing lip is flared in radial cross-section towards a free end of the second annular sealing lip, the free end being opposite a root portion of the second annular sealing lip at the second axial end of the solid median portion.

2. The sealing assembly according to claim 1,
wherein the annular support includes a cylindrical portion and a radially inwardly projecting flange,
wherein the solid median portion is located inside the cylindrical portion,
wherein the flange is located between the first annular sealing lip and the solid median portion, and
wherein the solid median portion has a first axial length (a) from a first side of the flange opposite the first annular sealing lip to the second axial end and the second annular seal lip has a second axial length (b) from the root portion to the free end of the second annular lip.

3. The sealing assembly according to claim 2,
wherein the solid median portion and the second annular sealing lip are configured such that 0.4≤(b/a)≤1.15.

4. The sealing assembly according to claim 3,
wherein the free end of the second annular sealing lip has a maximum radial thickness (c) greater than a minimum radial thickness of the root portion of the second annular sealing lip, and
wherein
$$0.9 \leq ( c / b ) \leq 1.9 .$$

5. The sealing assembly according to claim 2,
wherein the free end of the second annular sealing lip has a maximum radial thickness (c) greater than a minimum radial thickness of the root portion of the second annular sealing lip, and
wherein
$$0.9 \leq ( c / b ) \leq 1.9 .$$

6. The sealing assembly according to claim 5,
wherein the flange is completely embedded in the elastomeric annular body.

7. The sealing assembly according to claim 6,
wherein the flange is configured to provide axial and radial support for the solid median portion.

8. The sealing assembly according to claim 6,
wherein a connecting portion of the elastomeric annular body extends from the solid median portion past a radially inner edge of the flange to a root portion of the first annular sealing lip.

9. The sealing assembly according to claim 8,
wherein the flange has first radial length (g),
wherein the connecting portion is annular and has a solid radial cross-section and has a second radial length (f) from the radially inner edge of the flange to a radial inner edge of the connecting portion, and
wherein
$$1.5 \leq ( g / f ) \leq 4.$$

10. The sealing assembly according to claim 9,
including at least three annular ribs on the radial inner side of the second annular seal lip configured to form during use a sliding sealing contact point on a shock-absorber rod.

11. The sealing assembly according to claim 9,
wherein the second annular sealing lip has a tapered radially outer surface facing the cylindrical portion of the annular support, the taper being directed towards the first annular sealing lip.

12. A bicycle shock absorber comprising:
a sliding rod,
a tubular element, and
a sealing assembly according to claim 1 interposed between the sliding rod and the tubular element.

13. A bicycle shock absorber comprising:
a sliding rod,
a tubular element, and
a sealing assembly according to claim 9 interposed between the sliding rod and the tubular element.
